(19) United States
(12) Patent Application Publication
(10) Pub. No.: US 2015/0294799 A1
(43) Pub. Date: Oct. 15, 2015

(54) ELECTRODE FOR ENERGY STORAGE DEVICE AND ENERGY STORAGE DEVICE USING THE SAME

(71) Applicant: EPISTAR CORPORATION, Hsinchu (TW)

(72) Inventors: Saad MOHAMED, Taipei (TW); Chih-Jung CHEN, Taipei (TW); Ru-Shi LlU, Taipei (TW); Shu-Fen HU, Taipei (TW); Hsin-Mao LlU, Hsinchu (TW); Ai-Sen LlU, Hsinchu (TW)

(73) Assignee: EPISTAR CORPORATION, Hsinchu (TW)

(21) Appl. No.: 14/253,469

(22) Filed: Apr. 15, 2014

(51) Int. Cl. H01G 11/26; H01G 11/60; H01G 11/62; H01M 10/0569; H01M 4/50; H01M 4/36; H01M 4/48; H01M 10/0568; H01G 11/46; H01G 11/56

(52) U.S. Cl. CPC H01G 11/26; H01G 11/46; H01G 11/60; H01G 11/62; H01G 11/56; H01M 4/502; H01M 4/362; H01M 4/483; H01M 10/0568; H01M 10/0569; H01M 10/052

(57) ABSTRACT

Disclosed are an electrode for an energy storage device and an energy storage device using the same. The electrode for an energy storage device comprises a porous electrical conductive material and a plurality of Co—Mn composite oxide nanowires on the porous electrical conductive material. The energy storage device comprises an anode comprising the aforementioned electrode; a cathode; and an electrolyte between the anode and the cathode.

### TECHNICAL FIELD

The application relates to an electrode for energy storage device and energy storage device using the same, in particular to an electrode for an energy storage device having improved electrochemical performance and an energy storage device using the same.

### DESCRIPTION OF BACKGROUND ART

Developing new energy storage devices for producing an electric current is necessary because of growing concerns over fossil fuel usage, global warming, and resource consumption. Among the energy storage devices, batteries and supercapacitors (SCs) are widely used. As the demand for the portable electronic devices increases, batteries have been widely used. Batteries and supercapacitors (SCs) utilize different mechanisms for electrical energy storage. Therefore, while batteries can store significantly more energy per unit volume than supercapacitors (SCs), supercapacitors (SCs) provide a larger volume power density, i.e., larger amount of power (time rate of energy transfer) per unit volume. This makes charge and discharge cycles of supercapacitors (SCs) much faster than batteries, and makes supercapacitors (SCs) suitable for applications that require a high current in a short time period, such as vehicles. However, to meet the commercial demand, improvement of the electrode is strongly needed in both the batteries and supercapacitors (SCs) for better electrochemical performance.

### SUMMARY OF THE DISCLOSURE

Disclosed are an electrode for an energy storage device and an energy storage device using the same. The electrode for an energy storage device comprises a porous electrical conductive material and a plurality of Co—Mn composite oxide nanowires on the porous electrical conductive material. The energy storage device comprises an anode comprising the aforementioned electrode; a cathode; and an electrolyte between the anode and the cathode.

### BRIEF DESCRIPTION OF THE DRAWINGS

FIG. 1 shows the X-ray diffraction (XRD) pattern of an electrode for an energy storage device comprising Co—Mn composite oxide nanowires (NWs) grown on foamed Ni in accordance with the first embodiment of the present application.

FIG. 2 shows the morphology of the foamed Ni and Co—Mn composite oxide NWs grown on the foamed Ni. FIGS. 2(a) to 2(c) show the images by field-emission scanning electron microscopy (FE-SEM), and FIG. 2(d) shows the image by transmission electron microscopy (TEM).

FIG. 3 shows an energy storage device using the electrode comprising Co—Mn composite oxide NWs on porous electrical conductive material in accordance with the second embodiment of the present application. A battery is illustrated.

FIG. 4 shows the representative charge-discharge curves of the battery in accordance with the second embodiment of the present application.

FIG. 5 shows the multiple-step charge-discharge at different current densities of the battery in accordance with the second embodiment of the present application.

FIG. 6 shows another energy storage device using the electrode comprising Co—Mn composite oxide NWs on porous electrical conductive material in accordance with the third embodiment of the present application. A supercapacitor (SC) is illustrated.

FIGS. 7(a) to 7(c) show the CV (Current density v.s. Voltage) curves obtained at various scan rates of the supercapacitor (SC) in accordance with the third embodiment of the present application.

FIG. 8 is a table showing the specific capacitances of the supercapacitor (SC) in accordance with the third embodiment of the present application.

FIG. 9 shows the cycling stability of the supercapacitor (SC) in accordance with the third embodiment of the present application.

### DETAILED DESCRIPTION OF PREFERRED EMBODIMENTS

In the present application, an electrode for an energy storage device and an energy storage device using the same are disclosed. The electrode for an energy storage device comprises Co—Mn composite oxide nanowires (NWs) on a porous electrical conductive material. The energy storage device can be batteries and supercapacitors (SCs), which both show good electrical performance.

The first embodiment of the present application illustrates an electrode for an energy storage device comprising Co—Mn composite oxide nanowires (NWs) on a porous electrical conductive material. In the present embodiment, Co—Mn composite oxide nanowires (NWs) comprise MnCo₂O₄ nanowires (NWs). The MnCo₂O₄ nanowires (NWs) are grown on a porous metal material. In the present embodiment, the porous metal material comprises foamed metal material, for example, foamed nickel (Ni). It is noted that other metal, for example, foamed copper (Cu) may also be used. In addition to the porous metal material, other porous electrical conductive material, for example, a carbon cloth which is constituted by carbon fibers may be used.

In the present embodiment, the method for forming the MnCo₂O₄ nanowires (NWs) on a porous Ni may be hydrothermal synthesis which comprises the following steps: First, a mixture solution comprising manganese nitrate tetrahydrate [Mn(NO₃)₂.4H₂O], cobalt nitrate hexahydrate [Co(NO₃)₂.6H₂O], ammonium fluoride (NH₄F), and urea are provided. To be more specific, 0.02 mole of Mn(NO₃)₂.6H₂O, 0.04 mole of Co(NO₃)₂.4H₂O, 0.04 mole of NH₄F, and 0.1 mole of urea are mixed and put inside an autoclave. Second, a porous Ni substrate, for example, a foamed Ni is partly immersed in the above mixture solution with a heat treatment at a temperature of 100-200° C. for a time period of 6-8 hours to grow MnCo₂O₄ nanowires (NWs), and then followed by annealing at a temperature of 300-400° C. for a time period of 2-4 hours. To be more specific, the heat treatment for the growth of MnCo₂O₄ NWs is at a temperature of 140° C. for a time period of 7 hours, and the anneal is at a temperature of 350° C. for a time period of 3 hours. In the present embodiment, the porous metal material comprises foamed metal material. It is noted the method to make the metal material porous can also be a de-alloying method, a powder sintering method, or an electrochemical method.

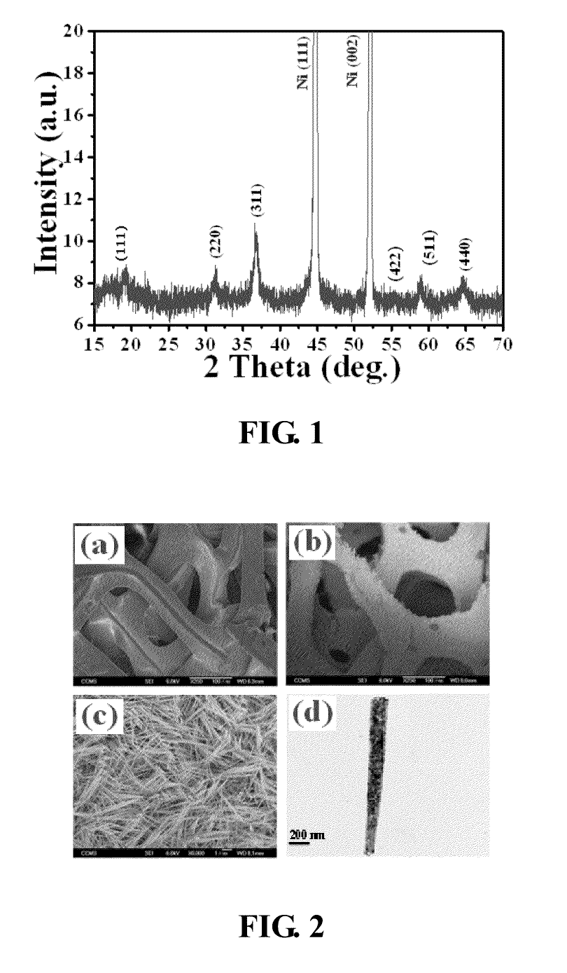

FIG. 1 is the X-ray diffraction (XRD) pattern of MnCo₂O₄ NWs grown on foamed Ni formed by the above method. Except for two typical peaks which indicating Ni (at approximately 2θ of 44.5° and 51.9°), all of the diffraction peaks can be clearly indexed and assigned to MnCo₂O₄. Because no other peak is detected, it indicates the absence of any impurities (for example, NiO, MnO₂, or CoO) in the product and the growth of MnCo₂O₄ on the foamed Ni is uniform.

FIG. 2 shows the morphology of MnCo₂O₄ NWs grown on the foamed Ni by field-emission scanning electron microscopy (FE-SEM) and transmission electron microscopy (TEM). FIG. 2(a) shows the foamed Ni used in the above embodiment. FIG. 2(b) shows the MnCo₂O₄ NWs uniformly grown on the foamed Ni. FIG. 2(c) shows the higher-magnification image of the MnCo₂O₄ NWs. FIG. 2(d) shows TEM image of a single MnCo₂O₄ NW. It can be observed from FIG. 2(c) and FIG. 2(d) that MnCo₂O₄ NWs grown on Ni in the above embodiment comprise a line shape. Typical NWs have diameters of about 100 nm and the length is larger than 100 nm. As FIG. 2(d) shows, the length is more than five times of the diameters. Most of NWs have a length larger than 1 μm.

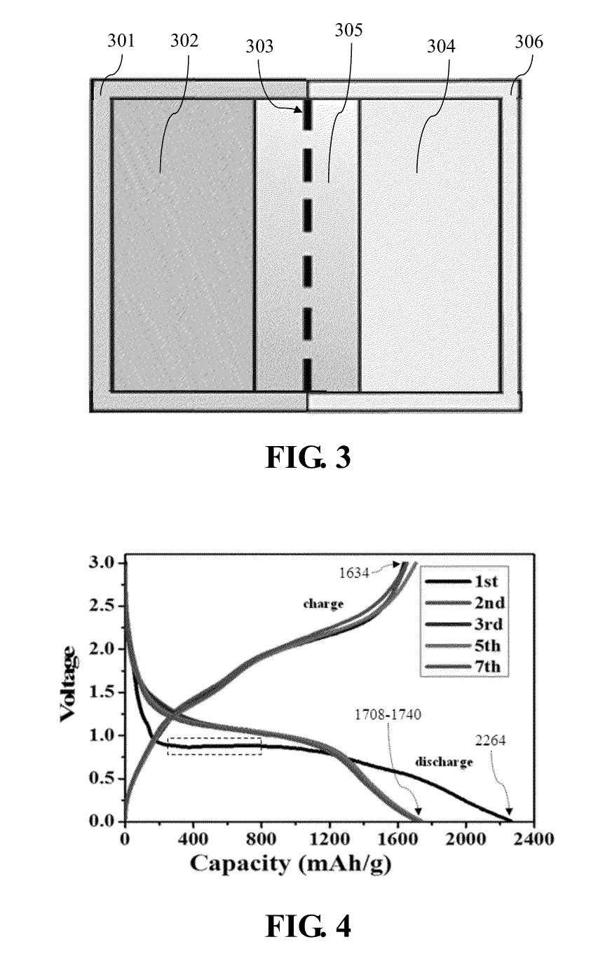

The second embodiment of the present application illustrates an energy storage device using the electrode comprising Co—Mn composite oxide NWs on porous electrical conductive material. In the present embodiment, a battery having an anode formed of MnCo₂O₄ NWs on foamed Ni illustrated in the above embodiment is illustrated. As shown in FIG. 3, the battery comprises a first cap 301, an anode 302, a separator 303, a cathode 304, an electrolyte 305, and a second cap 306. The first cap 301 and the second cap 306 are sealed to pack the anode 302, the separator 303, the cathode 304, and the electrolyte 305. The first cap 301 and the second cap 306 also function as conductive ends of the battery to conduct the produced current out. The material of the first cap 301 and the second cap 306 comprises stainless steel. The anode 302 comprises the MnCo₂O₄ NWs grown on the foamed Ni illustrated in the first embodiment above. The cathode 304 can be LiCoO₂, LiFePO₄, LiNiO₂, and/or LiMn₂O₄ in the present embodiment. In other embodiment, the cathode 304 can be Li. The separator 303 comprises macromolecular compounds, such as a polymer material, to separate the anode 302 and the cathode 304. The electrolyte 305 may be added in while the first cap 301 and the second cap 306 are packed together. The electrolyte 305 comprises an organic solution and is between the anode 302 and the cathode 304. In the present embodiment, the electrolyte 305 comprises LiPF₆ (lithium hexafluorophosphate) dissolved in EC (ethylene carbonate) and DMC (dimethyl carbonate).

FIG. 4 shows the representative charge-discharge curves of the above battery, wherein Li is selected as the cathode 304. The first, second, third, fifth, and seventh cycles at a current density of 200 mA/g are shown. The initial (first cycle) discharge and charge capacities are 2264 and 1634 mAh/g (indicated in the figure), respectively. The plateau (the dashed rectangle in the figure) of the first cycle discharge appears at about 0.9 V, and then shifts to about 1.2 or 1.3 V in later cycles, which indicates that irreversible reactions occur during the first cycle. The discharge capacities of the electrode in the second, third, fifth, and seventh cycles range from 1708 mAh/g to 1740 mAh/g, indicating high stability of the electrode. The irreversible capacity loss after the first cycle is less than 25% ((2264−1708)/2264=24.5%).

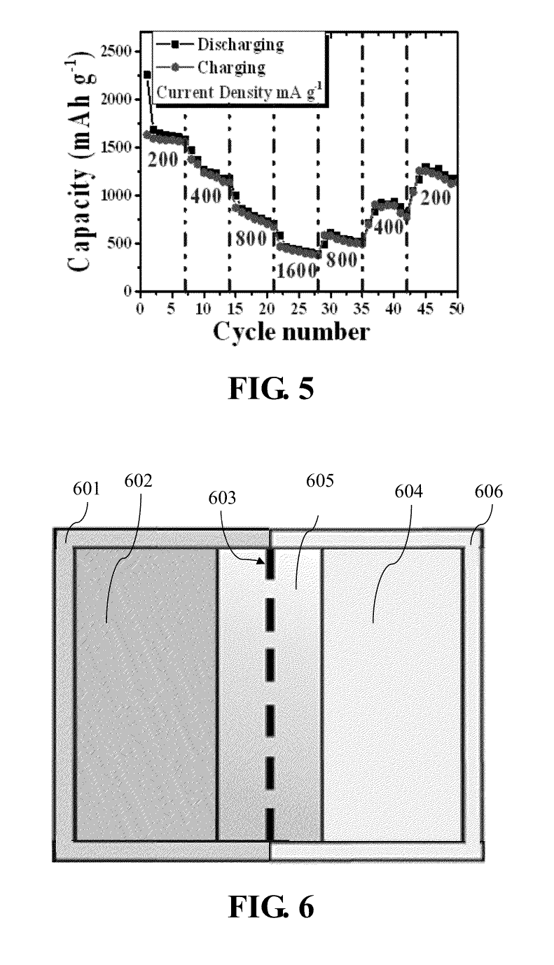

FIG. 5 shows the multiple-step charge-discharge at different current densities ranging from 200 mA/g to 1600 mA/g for the above battery. It shows that the discharge capacity is initially about 1600 mAh/g at current densities of 200 mA/g, and then decreases to 1180 mAh/g, 708 mAh/g, and 388 mAh/g at current densities of 400 mA/g, 800 mA/g, and 1600 mA/g, respectively. Then, the current density is returned to the initial values in a reversed order. The capacity also recovers to 515 mAh/g, 811 mAh/g, and 1174 mAh/g at current densities of 800 mA/g, 400 mA/g, and 200 mA/g, respectively. These results show that MnCo₂O₄ NWs anode for the battery has significantly high capability for capacity retention.

The high capacity and good capacity retention can be attributed to the morphology and structure of the electrode comprising Co—Mn composite oxide NWs on porous electrical conductive material due to the following characteristics: (1) Co—Mn composite oxide NWs directly grown on porous electrical conductive material have high electronic conductivity because Co—Mn composite oxide NWs are firmly bound to the electrical conductive material, yielding significantly good adhesion and electrical contact; and (2) the line shape of the Co—Mn composite oxide NWs and the loose and open spaces between neighboring NWs because of the 3D configuration of the Co—Mn composite oxide NWs on porous electrical conductive material significantly enhance the contact area between electrolyte and Co—Mn composite oxide; therefore, the diffusion of the electrolyte is easier between the Co—Mn composite oxide NWs, and tolerance for the strain induced by the volume change during electrochemical reactions is increased because of porous electrical conductive material. These conditions lead to higher lithiation and delithiation efficiencies under electrolyte penetration.

The third embodiment of the present application illustrates another energy storage device using the electrode comprising Co—Mn composite oxide NWs on porous electrical conductive material. In the present embodiment, a supercapacitor (SC) having two electrodes formed of MnCo₂O₄ NWs on foamed Ni in the first embodiment is illustrated. As shown in FIG. 6, the supercapacitor (SC) comprises a first cap 601, an anode 602, a separator 603, a cathode 604, an electrolyte 605, and a second cap 606. The first cap 601 and the second cap 606 are sealed to pack the anode 602, the separator 603, the cathode 604, and the electrolyte 605. The first cap 601 and the second cap 606 also function as conductive ends of the supercapacitor (SC) to conduct the produced current out. The material of the first cap 601 and the second cap 606 comprises stainless steel. The anode 602 and the cathode 604 comprise the MnCo₂O₄ NWs grown on the foamed Ni illustrated in the first embodiment above. The separator 603 comprises porous materials, such as glass fiber to separate the anode 602 and the cathode 604. The electrolyte 605 may be added in while the first cap 601 and the second cap 606 are packed together. In the present embodiment, the electrolyte 605 comprises LiClO₄ (lithium perchlorate)/PC (propylene carbonate) non-aqueous electrolyte between the anode 602 and the cathode 604. The above non-aqueous electrolyte provides a wider range of voltage of the supercapacitor (SC) for application.

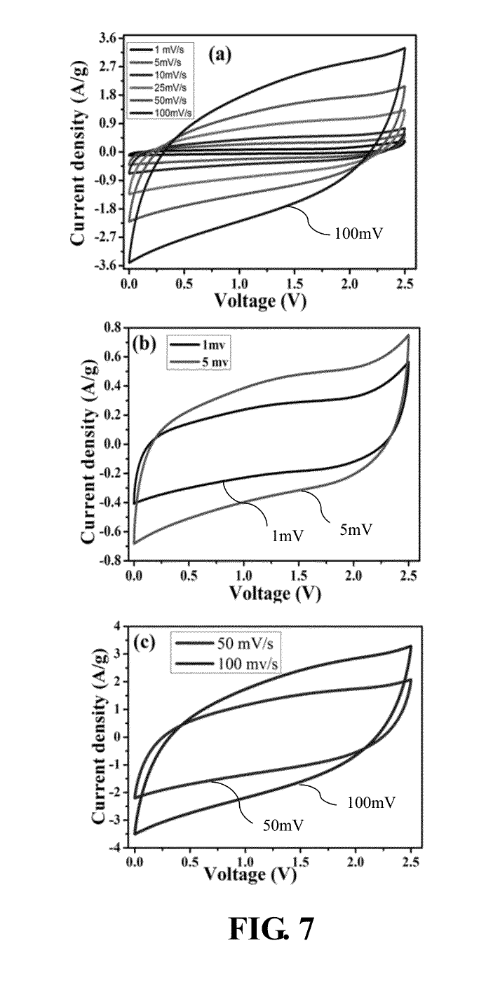

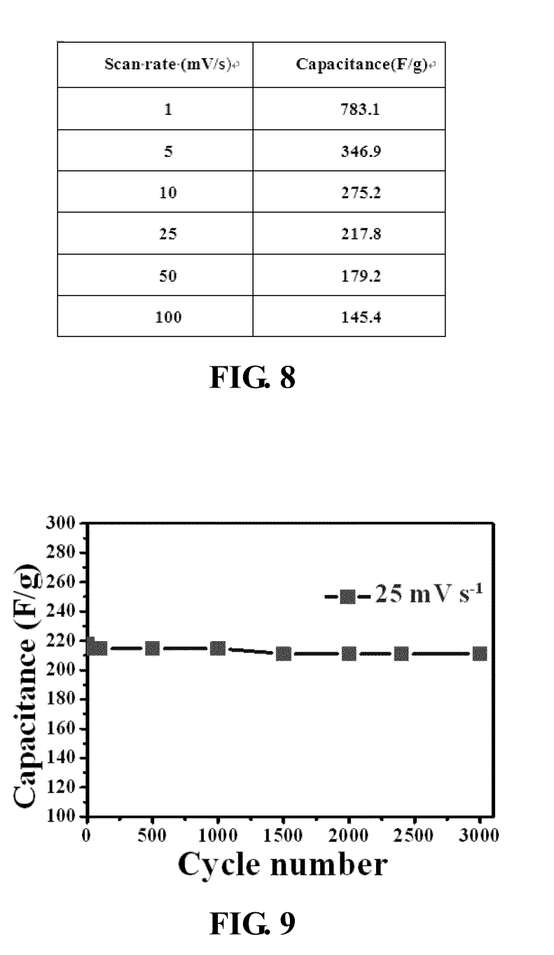

FIG. 7(a) shows the CV (Current density v.s. Voltage) curves obtained at various scan rates between 1 and 100 mV/s of the above supercapacitor (SC). To show the curves more clearly, the CV curves of the scan rates at 1 and 5 mV/s are shown in FIG. 7(b), and the CV curves of the scan rates at 50 and 100 mV/s are shown in FIG. 7(c). The corresponding specific capacitances of the supercapacitor (SC) are shown in FIG. 8. The CV curves in FIGS. 7(a) to 7(c) are approximately in a parallelogram shape and show good capacitive behaviors for scan rates up to 50 mV/s. This indicates the low contact resistance. At higher scan rates (100 mV/s), the CV curve deviates from a parallelogram shape and is closer to an oval shape, which can be ascribed to the inherent resistivity of the electrode. Such resistivity can be attributed to intensified polarization, rapid charge transfer, and cationic diffusion. FIG. 8 is a table showing the specific capacitances of the supercapacitor (SC), wherein the capacitances are 783.1, 346.9, 275.2, 217.8, 179.2, and 145.4 F/g at scan rates of 1, 5, 10, 25, 50, and 100 mV/s, respectively. The result shows the supercapacitor (SC) comprising the line shape Co—Mn composite oxide NWs on porous electrical conductive material as the electrodes has high specific capacitances. FIG. 9 shows the cycling stability of the supercapacitor (SC) at 25 mV/s. The obtained capacitance values, which vary from 217 F/g for cycle 1 to 210 F/g for cycle 3000, are almost constant up to 3000 cycles and show 96.8% (201/217=96.8%) retention of the initial capacitance.

Such capacitive behavior may be attributed to the line shape of the Co—Mn composite oxide NWs and the loose and open spaces between neighboring NWs because of the 3D configuration of the Co—Mn composite oxide NWs on porous electrical conductive material, which facilitates fast electron transfer. NWs can function as transport channels for storing and transferring more electrical charges to the electrodes. The line shape NWs have larger surface areas that can increase the effective interfacial area for reaction. In general, excellent electrochemical performance could be derived from the features of the line shape Co—Mn composite oxide NWs on porous electrical conductive material, which significantly increase the number of electroactive sites. Furthermore, the direct growth of NWs on porous electrical conductive material ensures good mechanical adhesion as well as enhanced electrical contact between NWs and porous electrical conductive material.

The above-mentioned embodiments are only examples to illustrate the theory of the present invention and its effect, rather than be used to limit the present invention. Other alternatives and modifications may be made by a person of ordinary skill in the art of the present application without escaping the spirit and scope of the application, and are within the scope of the present application.

What is claimed is:

1. An electrode for an energy storage device, comprising a porous electrical conductive material and a plurality of Co—Mn composite oxide nanowires on the porous electrical conductive material.

2. The electrode for an energy storage device as claimed in claim 1, wherein the porous electrical conductive material comprises porous metal material.

3. The electrode for an energy storage device as claimed in claim 1, wherein the porous electrical conductive material comprises foamed Ni or foamed Cu.

4. The electrode for an energy storage device as claimed in claim 1, wherein the Co—Mn composite oxide nanowires comprise a line shape.

5. The electrode for an energy storage device as claimed in claim 1, wherein the plurality of Co—Mn composite oxide nanowires are directly formed on the porous electrical conductive material.

6. An energy storage device, comprising:
an anode comprising a porous electrical conductive material and a plurality of Co—Mn composite oxide nanowires on the porous electrical conductive material;
a cathode; and
an electrolyte between the anode and the cathode.

7. The energy storage device as claimed in claim 6, wherein the energy storage device is a battery with a capacity larger than 1700 mAh/g.

8. The energy storage device as claimed in claim 6, wherein the energy storage device is a battery with an irreversible capacity loss less than 25% after a first charge-discharge cycle.

9. The energy storage device as claimed in claim 6, wherein the cathode comprises LiCoO₂, LiFePO₄, LiNiO₂, LiMn₂O₄, or Li.

10. The energy storage device as claimed in claim 6, wherein the electrolyte comprises an organic solution.

11. The energy storage device as claimed in claim 6, wherein the electrolyte comprises LiPF₆ (lithium hexafluorophosphate) dissolved in EC (ethylene carbonate) and DMC (dimethyl carbonate).

12. The energy storage device as claimed in claim 6, wherein the energy storage device is a supercapacitor, and the cathode comprises the same material as the anode.

13. The energy storage device as claimed in claim 12, wherein the electrolyte comprises a non-aqueous material.

14. The energy storage device as claimed in claim 12, wherein the electrolyte comprises a mixture of LiClO₄ (lithium perchlorate) and PC (propylene carbonate).

15. The energy storage device as claimed in claim 12, wherein a capacitance of the energy storage device is larger than 210 F/g.

16. The energy storage device as claimed in claim 12, wherein a ratio of a capacitance after more than 1000 charge-discharge cycles to a first charge-discharge cycle is larger than 96%.

17. The energy storage device as claimed in claim 6, wherein the porous electrical conductive material comprises porous metal material.

18. The energy storage device as claimed in claim 6, wherein the porous electrical conductive material comprises foamed Ni or foamed Cu.

19. The energy storage device as claimed in claim 6, wherein the Co—Mn composite oxide nanowires comprise a line shape.

20. The energy storage device as claimed in claim 6, wherein the plurality of Co—Mn composite oxide nanowires are directly formed on the porous electrical conductive material.
